(19) United States
(12) Patent Application Publication
(10) Pub. No.: US 2004/0048032 A1
(43) Pub. Date: Mar. 11, 2004

(54) Vehicle part and method of making the same

(75) Inventor: Rainer Ankele, Ebersberg (DE)

Correspondence Address: Michael S. Brodbine, Brooks & Kushman P.C., 22nd Floor, 1000 Town Center, Southfield, MI, 48075-1351, US

(73) Assignee: Lear Corporation, Southfield, MI

(21) Appl. No.: 10/236,370

(22) Filed: Sep. 6, 2002

(51) Int. Cl. B32B 5/16; B32B 1/04; B32B 3/02

(52) U.S. Cl. 428/68; 428/297.4; 442/413; 264/241; 264/257

(57) ABSTRACT

An automotive component comprising a composite material. The composite material comprises thermoplastic polymeric material, natural fiber, and an adhesion promoter comprising silane and titanate. The process for making the automotive component comprising, providing a composite material comprising thermoplastic polymeric material and natural fiber, exposing the composite material to an adhesion promoter comprising silane and titanate, and forming the composite material exposed to the adhesion promoter in the mold to form a molded automotive component.

### BACKGROUND OF THE INVENTION

1. Field of the Invention

The invention relates to motor vehicle interior parts and a method of making the same.

2. Background Art

Motor vehicle interiors have many interior components, made of one or more substrates. Examples of these types of interior components include, but are not necessarily limited to, interior door panels, pillars, headliners, floor panels, and rear deck storage panels. These types of interior components are required to be sufficiently structurally sound and lightweight while being easily made from readily accessible and cost efficient materials. As a result of the high volume of motor vehicles being manufactured each year, substantial efforts have been made to make motor vehicle parts from environmentally friendly materials.

One particular source of materials that is considered environmentally friendly is materials that would otherwise be waste. Among other advantages, employing the use of material that would otherwise be waste reduces the volume of material that would otherwise be burned or deposited in landfills. Natural materials are considered because of their renewable natural fiber content. One such material is flax fiber.

As such, it has been known to incorporate composite panels/substrates comprising flax or other natural fibers and thermoplastic materials in the manufacture of motor vehicle composite parts. Examples of such composite substrates and their use in various interior parts of the motor vehicles are disclosed in U.S. Pat. Nos. 6,136,415; 5,837,181; and 5,709,925.

One drawback in the use of natural fibers with thermoplastic materials is the high water absorption of the natural fiber resulting in the low adhesion to the hydrophobic thermoplastic material, which is typically hydrophobic.

Accordingly, it would be desirable to provide a process for manufacturing vehicle interior parts that overcomes this problem.

### SUMMARY OF THE INVENTION

In at least one embodiment, the present invention takes the form of an automotive component comprising a composite material. The composite material comprises a thermoplastic polymer material, natural fiber, and an adhesion promoter. The adhesion promoter comprises a mixture of silane and titanate. In at least another embodiment, the adhesion promoter further comprises a bond assisting agent comprising peroxide.

In at least another embodiment of the present invention, the invention takes the form of a process for making an automotive component. The process comprises providing a composite material comprising thermoplastic polymeric material and natural fiber, exposing the composite material to an adhesion promoter comprising silane and titanate, and forming the composite material exposed to the adhesion promoter in the mold to form a molded automotive component.

### BRIEF DESCRIPTION OF THE DRAWINGS

The invention will now be described in greater detail in the following way of example only and with reference to the attached drawings, in which:

FIG. 1 is a front perspective view of a motor vehicle interior component manufactured in accordance with the present invention;

FIG. 2 is a cross sectional view of the motor vehicle interior component taken along line 2-2 of FIG. 1; and

FIGS. 3a-3c illustrate a portion of the general method for making a motor vehicle interior component in accordance with the present invention.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

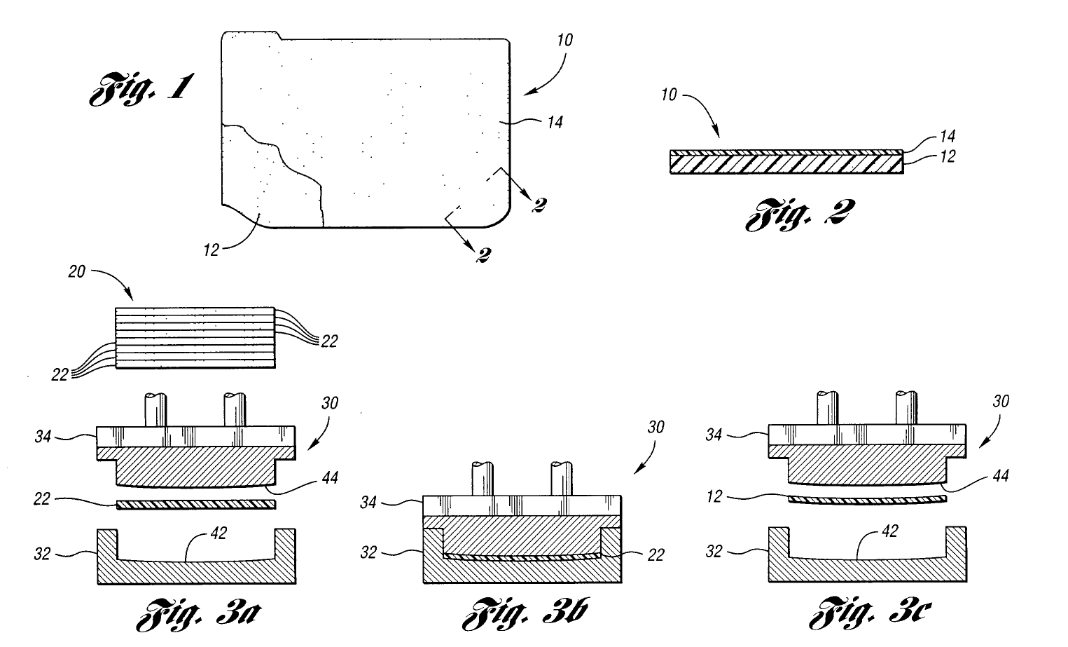

FIG. 1 illustrates a motor vehicle interior part, such as molded door panel 10, made in accordance the present invention. The door panel 10 comprises a rigid substrate 12 and a cover layer 14 disposed over and secured to the rigid substrate. The rigid substrate 12 substantially comprises a molded composite mat of natural fibrous material and a thermoplastic matrix material. The molded mat is preferably formed from a pre-formed needle-punched mat 22 (FIG. 3). The mat 22, prior to molding, preferably has an area weight of about 1,200-2,500 g/m², more preferably about 1,500-2,000 g/m², and most preferably about 1,800 g/m². The mat 22 molding, preferably has a thickness of about 5-25 mm, more preferably about 5-15 mm, and most preferably about 10 mm.

The natural fibrous material is preferably a natural cellulosic fiber material. The natural cellulosic fiber material may, for example, include straw, cotton, flax, kenaf, sisal, bagasse, hemp, ramie, jute or the like or combinations thereof, and most preferably comprises flax. The natural fibers preferably have an average length of about 15-100 mm, more preferably about 25-75 mm, and most preferably about 40-60 mm. The substrate's 12 ratio of thermoplastic matrix material to the natural fiber material is preferably within the range of about 30:70 to about 70:30, more preferably about 40:60 to about 60:40, and most preferably about 50:50. The mat 22 can be made by any suitable manner or can be obtained from several suppliers. Particularly preferred mats 22 include needle-punched flax-PP (polypropylene), jute-PP, kenaf-PP and hemp-PP mats having a 50:50 wt. ratio, an area weight of about 1,800 g/m², and a thickness about 10 mm. Most of these types are available from Polyvlies of Hörstel-Bevergern, Germany.

The thermoplastic material preferably comprises polypropylene, however, other thermoplastic materials such as, but not necessarily limited to, polyethylene, polyamides, polyester, polyurethane and polyvinyl chloride could also be used. In one embodiment, the thermoplastic material is in fiber form and preferably has a length of about 15-100 mm, more preferably about 25-75 mm, and most preferably about 50 mm and a fineness of about 1-25 dtex, more preferably about 2-15 dtex, and most preferably about 3-8 dtex.

The cover layer 14 may be any type of permeable or non-permeable material that is used in the manufacture of automotive interior parts such as, but not limited to, cloth, fabric, vinyl or leather. The cover layer 14 may be adhered to the substrate 12 by conventional means, such as glueing, after the substrate 12 has been formed, or could be secured to the substrate 12 during the forming step or process of substrate 12.

To improve the adhesion of the natural fiber to the thermoplastic matrix, and thus to improve the mechanical properties such as flexural strength of the composite part, an adhesion promoter is provided.

In one embodiment, the adhesion promoter comprises silane and titanate. In this embodiment, the silane and titanate are present in a wt. ratio of silane to titanate in an amount of about 3:1 to about 12:1, more preferably about 5:1 to about 8:1, and most preferably about 6.5:1.

In another embodiment, the adhesion promoter preferably comprises a mixture of silane, titanate, and a bond assisting agent. In this embodiment, the silane is preferably present in the adhesion promoter in an amount of about 60 to about 85 weight percent, based on the total weight of the adhesion promoter, more preferably in an amount of about 65 to about 75 weight percent, and most preferably in an amount of about 72 weight percent. In this embodiment, the titanate is preferably present in the adhesion promoter in an amount of about 10 to about 40 weight percent, based on the total weight of the adhesion promoter, more preferably in an amount of about 15 to about 30 weight percent, and most preferably in an amount of about 21 weight percent. In this embodiment, the bond assisting agent is preferably present in the adhesion promoter in an amount of about 1 to about 15 weight percent, based on the total weight of the adhesion promoter, more preferably in an amount of about 3 to about 10 weight percent, and most preferably in an amount of about 7 weight percent. Without wishing to be bound to any particularly theory, the bond assisting agent is believed to crack the thermoplastic material chains to allow them to bond more effectively with the silane in the adhesion promoter.

While any suitable silanes may be used, it is preferred that silane be a liquid organofunctional silane. Suitable examples of organofunctional silanes include, but are not necessarily limited to, 3-aminopropyltriethoxysilane (AMEO), 3-glycidyloxypropyltrimetoxysilane (GLYMO), n-propyltrimethoxysilane (PTMO), 3 methacryloxypropyltrimethoxysilane (MEMO), 3 mercaptopropyltrimethoxysilane (MTMO), n-aminoethyl-3-aminopropyltrimethoxysilane (DAMO), triamino-functional propyltrimethoxysilane (TRIAMO), vinyltrimethyoxysilane (VTMO), and mixtures thereof. The most preferred silane is MEMO from Sivento Chemie of Germany.

In this embodiment, the titanate is preferably present in the adhesion promoter in an amount of about 10 to about 40 weight percent, based on the total weight of the adhesion promoter, more preferably in an amount of about 15 to about 30 weight percent, and most preferably in an amount of about 21 weight percent.

While any suitable titanate may be used, it is preferred that the titanate be a liquid organic titanate. Suitable examples of liquid organic titanates include, but are not necessarily limited to, tetraethyl titanate, tetraisopropyl titanate, tetra-n-proply titanate, tetra-n-butyl titanate, n-butyl polytitanate, tetra-2-ethylhexyl titanate, tetraisooctyl titanate, isostearoyl titanate, cresyl titanate (monomer), cresyl titanate (polymer), octylenglycole titanate, titanium acetylacetonate, and mixtures thereof. The most preferable titanates comprise tetra-n-butyl titanate, isostearoyl titanate; and titanium acetylacetonate, all available from DuPont™.

In this embodiment, the bond assisting agent is preferably present in the adhesion promoter in an amount of about 1 to about 15 weight percent, based on the total weight of the adhesion promoter, more preferably in an amount of about 3 to about 10 weight percent, and most preferably in an amount of about 7 weight percent. Without wishing to be bound to any particularly theory, the bond assisting agent is believed to crack the thermoplastic material chains to allow them to bond more effectively with the silane in the adhesion promoter.

While any suitable bond assisting agent can be used, it is preferred that the bond assisting agent be an organic compound capable of providing reactive free radicals. Suitable examples include, but are not necessarily limited to, azo- and peroxide-compounds, the like, and mixtures thereof, with peroxides being most preferred. Suitable examples of peroxide-compounds include, but are not necessarily limited to, tert-amyl peroxybenzoate, benzoly peroxide, 2,2bis(tert-butylperoxy)butane, 1-1 bis(tert-butylperoxy)cyclohexane, 2,5bis(tert-butylperoxy)-2,5-dimethylhexane, tert-butyl hydroperoxide, tert-butyl peroxide, tert-butyl peroxybenzonate, tert-butylperoxy isopropyl carbonate, cumene hydroperoxide, cyclohexanone peroxide, dicumyl peroxide, hydrogen peroxide, lauroyl peroxide, and mixtures thereof. The most preferred agents comprise tert-butyl hydroperoxide, dicumyl peroxide, and lauroyl peroxide.

The adhesion promoter is prepared by mixing the silane, titanate and the bond assisting agent together. The order of addition/mixing is not necessarily important, however in one embodiment, the titanate is first added to the silane with the bond assisting agent then being added to the silane/titanate mixture. An amount of a suitable solvent, (preferably isopropyl alcohol or methanol), is then preferably added to the adhesion promoter to form an adhesion promoter/solvent mixture. The amount of solvent required can vary depending upon the particular application and the manner in which the adhesion promoter mixture is applied to the mat. In one embodiment, the solvent is added to the adhesion promoter in an amount of about 75 to 150 times the weight of the adhesion promoter mixture.

The amount of adhesion promoter that is added to the mat is relatively small and is preferably based upon the weight of the natural fiber in the mat. The ratio of the weight of the adhesion promoter (not including solvent) to the weight of the natural fiber in the mat is preferably between 1:25 and about 1:75, and is most preferably about 1:50.

In one embodiment, the adhesion promoter is added, i.e. exposed, to the thermoplastic/natural fiber mat 22 (FIG. 3) prior to the substrate 12 being formed in a heated mold. The manner of addition of the adhesion promoter can be any suitable manner, and is preferably done by dipping the mat 22 in a bath of the adhesion promoter/solvent mixture or spraying the adhesion promoter/solvent mixture on the mat 22. After the mat 22 has been exposed to the adhesion promoter/solvent mixture, in one embodiment, the mat 22 is then compressed, preferably between two heated rolls, to distribute the adhesion promoter solution throughout the mat 22. The mat 22 is then heat molding in accordance with any conventional molding processing.

An exemplary molding process is illustrated in FIGS. 3a-3c. In FIG. 3a, there is shown a supply 20 of a plurality of premolded needle-punched thermoplastic/natural fiber composite mats 22 that already had the adhesion promoter of the present invention suitably distributed throughout. These treated mats 22 are then placed in a conventional mold apparatus 30. In one embodiment, the mold apparatus 30 has a lower mold or platen 32 and an upper mold or platen 34. The molds 32 and 34 have molding surfaces 42 and 44 respectively that cooperate with each other to form the general shape of the molded part (substrate 12). The unmolded composite mat 22 is placed between the molding surfaces 42 and 44 of the molding apparatus 30 as shown in FIG. 3a. The molds 32 and 34 are moved together as shown in FIG. 3b wherein the mat 22 is heated so that the thermoplastic material envelopes the fibrous natural material to form the substrate 12. After the substrate 12 is formed, the molds 32 and 34 are separated so that substrate 12 can be removed from the mold 30. Substrate 12 can then have a cover layer 14 adhered thereto by conventional means as discussed above or alternatively, the molding operation could be modified to include the layer of cover material 14 in the mold 30 so that the part 12 is molded with the cover layer 14 on the part 12. It should also be noted that other layers, such as a foam layer, could be conventionally disposed between the substrate 12 and the cover 14. It should also be noted that the substrate 12 could remain uncovered, especially if used for parts other than door panels, such as a headliners.

Having generally described the present invention, a further understanding can be obtained by reference to certain examples which are provided herein for purposes of illustration only and are not intended to be limiting unless otherwise specified.

### EXAMPLE

Natural fiber/PP mats having a 50:50 wt. ratio from Polyvlies were cut to the size for a DIN A4 mold (approximately 29 cm×25 cm×10 mm). An adhesion promoter mixture prepared in accordance with the present invention was prepared. The adhesion promoter mixture comprised 1 g MEMO, 0.3 g ISTT and 0.19 g of dicumyl peroxide. The adhesion promoter mixture was then solvated in about 150 ml of a suitable solvent (isopropanol or methanol). The mat was then put in a small tub with the solvent/adhesion promoter mixture. The solvent/adhesion promoter mixture was absorbed into the mat so that the absorbed mat contained about one gram of silane per 50 grams of fiber. Thereafter, the mat was pressed between two rolls to distribute the solvent/adhesion promoter mixture uniformly into the mat. The mat was then dried for about two hours in an oven at about 80° C. The dried and adhesion promoter impregnated natural fiber/polypropylene mat was then heated in a contact heating at about 220° C. for approximately ninety seconds. The hot mat was then molded in a temperature mold to form a substrate suitable for testing. This substrate is referred to as the substrate of the present invention.

A similar mat, not treated with the adhesion promoter, was molded in a temperature mold in the same manner to form a substrate. This substrate is referred to as the test substrate. This test mat/substrate does not have any solvents or adhesion promoter mixture prepared in accordance with the present invention provided therein.

The test substrate and the substrate of the present invention are then tested in accordance with the following test methods:

| TEST | TEST METHOD | UNIT |
|---|---|---|
| Flexural Strength | EN ISO 178 | N/mm² |
| Flexural Modulus | EN ISO 178 | N/mm² |
| Impact Strength | EN ISO 179 | KJ/m² |

The properties of both substrates were found to be as follows:

| | | SUBSTRATE OF THE |
|---|---|---|
| PROPERTIES | TEST SUBSTRATE | PRESENT INVENTION |
| Flexural Strength | 27.7 | 37.7 |
| Flexural Modulus | 1470 | 2390 |
| Impact Strength | 21.6 | 23.9 |

The test results show an improvement in mechanical properties of the substrate prepared in accordance with the present invention. The increase flexural strength is about 35% and the increase in flexural modulus is about 75%. This allows lighter substrates to be used resulting in a tremendous cost savings.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An automotive component comprising a composite material, said composite material comprising:
thermoplastic polymeric material;
natural fiber; and
an adhesion promoter comprising silane and titanate.

2. The automotive component of claim 1 wherein the silane is present in the adhesion promoter in an amount of about 60-85 weight percent, based on the total weight of the adhesion promoter.

3. The automotive component of claim 1 wherein the titanate is present in the adhesion promoter in an amount of about 20-40 weight percent, based on the total weight of the adhesion promoter.

4. The automotive component of claim 1 wherein the adhesion promoter further comprises a bond assisting agent present in the adhesion promoter in an amount of about 1-15 weight percent, based on the total weight of adhesion promoter.

5. The automotive component of claim 4 wherein the bond assisting agent comprises a peroxide.

6. The automotive component of claim 3 wherein the titanate comprises a liquid organic titanate.

7. The automotive component of claim 2 wherein the silane comprises an organofunctional silane.

8. The automotive component of claim 1 further comprising a cover layer disposed over the composite material.

9. The automotive component of claim 1 wherein the adhesion promoter is present in the composite material in a weight ratio relative to the natural fiber in an amount of about of 1:25-1:75.

10. The automotive components of claim 1 wherein the natural fiber is selected from the group consisting of straw, cotton, flax, kenaf, sisal, bagasse, hemp, ramie, jute and combinations thereof.

11. The process for making an automotive component, said process comprising:
providing a composite material comprising thermoplastic polymeric material and natural fiber;
exposing the composite material to an adhesion promoter comprising silane and titanate; and
forming the composite material exposed to the adhesion promoter in the mold to form a molded automotive component.

12. The process of claim 11 wherein the silane is present in the adhesion promoter in an amount of about 60-85 weight percent, based on the total weight of the adhesion promoter.

13. The process of claim 11 wherein the titanate is present in the adhesion promoter in an amount of about 20-40 weight percent, based on the total weight of the adhesion promoter.

14. The process of claim 11 wherein the adhesion promoter further comprises a bond assisting agent present in the adhesion promoter in an amount of about 1-15 weight percent, based on the total weight of adhesion promoter.

15. The process of claim 14 wherein the bond assisting agent comprises a peroxide.

16. The process of claim 12 wherein the silane comprises an organofunctional silane.

17. The process of claim 11 further comprising disposing a cover layer disposed over the automotive component.

18. The process of claim 11 wherein the adhesion promoter is exposed to the natural fiber in a weight ratio relative to the natural fiber in an amount of about 1:25-1:75.

19. The process of claim 11, wherein the natural fiber is selected from the group consisting of straw, cotton, flax, kenaf, sisal, bagasse, hemp, ramie, jute and combinations thereof.

20. A treated automotive component comprising a molded composite material, said composite material comprising:
thermoplastic polymeric material; and
natural fiber;
the composite material, prior to being molded, being treated with an adhesion promoter comprising silane, titanate, and peroxide, the silane being present in the adhesion promoter in an amount of about 60-85 weight percent, based on the total weight of the adhesion promoter, the titanate being present in the adhesion promoter in an amount of about 20-40 weight percent, based on the total weight of the adhesion promoter, the peroxide being present in the adhesion promoter in an amount of about 1-15 weight percent, based on the total weight of adhesion promoter.
